(19) United States
(12) Patent Application Publication
(10) Pub. No.: US 2025/0155985 A1
(43) Pub. Date: May 15, 2025

(54) DISPLAY DEVICE, WEARABLE ELECTRONIC DEVICE, AND OPERATING METHOD OF ELECTRONIC DEVICE

(71) Applicant: Electronics and Telecommunications Research Institute, Daejeon (KR)

(72) Inventors: Yong Ho LEE, Daejeon (KR); Youn Hee GIL, Daejeon (KR); Seong Min BAEK, Daejeon (KR); Hee Sook SHIN, Daejeon (KR); Cho Rong YU, Daejeon (KR); Sung Jin HONG, Daejeon (KR)

(21) Appl. No.: 18/619,078

(22) Filed: Mar. 27, 2024

(30) Foreign Application Priority Data
Nov. 9, 2023 (KR) 10-2023-0154235

(51) Int. Cl. G06F 3/01; G06V 40/10; G06V 40/16; G06V 40/20

(52) U.S. Cl. CPC G06F 3/017; G06F 3/012; G06F 3/013; G06V 40/11; G06V 40/175; G06V 40/20; G06F 2203/011

(57) ABSTRACT

A display device, a wearable electronic device, and an operating method of an electronic device are proposed. According to the proposed technical idea, the display device includes a sensing unit configured to obtain movement information about at least one body part of a target user responding to an extended reality (XR) image output by a display panel, and a processor configured to generate the extended reality image from movements of the target user on the basis of the movement information, calculate an emotional empathy degree and a physical empathy degree for another user on the basis of the movement information the target user and movement information of the other user, and generate a final empathy degree of the target user for the other user on the basis of the emotional empathy degree and the physical empathy degree.

### CROSS REFERENCE TO RELATED APPLICATION

The present application claims priority to Korean Patent Application No. 10-2023-0154235, filed Nov. 9, 2023, the entire contents of which are incorporated herein for all purposes by this reference.

### BACKGROUND OF THE INVENTION

### Field of the Invention

The technical idea of the present disclosure relates to a display device and, more particularly, to a display device for generating a final empathy degree by using movement information of users.

### Description of the Related Art

Recently, as technology has advanced, various types of wearable display devices wearable on human bodies are being released. Among the wearable display devices, a device for extended Reality glasses (XR glasses) is a head-mounted (HMD) wearable device and is capable of providing extended reality (XR) services to a user by providing visual information through a display.

Technologies of measuring degrees of empathy are being studied so that users using the extended reality (XR) services may empathize with emotions of other users and the degrees of empathy are quantitatively expressed. When the degrees of empathy of the user are measured, physiological synchronization levels of the user may be expressed by the degrees of empathy, so the user's biological signals such as brain waves, an electrocardiogram, and skin conductance are used for the measurement. However, in this regard, other equipment in addition to the HMD wearable device may be required.

Accordingly, a technology for accurately measuring the degrees of empathy of the user by using only movement information obtained from a HMD wearable device is required.

### SUMMARY OF THE INVENTION

The problem to be solved by the technical idea of the present disclosure is to provide a display device for generating a final empathy degree of a user by using movement information about body parts of the user.

According to a first aspect of the present disclosure as a technical means for solving the above-described technical problem, there is provided a display device, including: a sensing unit configured to obtain movement information about at least one body part of a target user responding to an extended reality (XR) image output by a display panel; and a processor configured to generate the extended reality image from movements of the target user on the basis of the movement information, calculate an emotional empathy degree and a physical empathy degree for another user on the basis of the movement information the target user and movement information of the other user, and generate a final empathy degree of the target user for the other user on the basis of the emotional empathy degree and the physical empathy degree.

In an exemplary embodiment, the processor may obtain gaze information of each of the target user and the other user from the movement information of each of the target user and the other user, generate a gaze consistency degree between the target user and the other user by using the gaze information, obtains face information of each of the target user and the other user from the movement information of each of the target user and the other user, generate a facial expression similarity degree between the target user and the other user by using the face information, and generate the emotional empathy degree on the basis of at least one of the gaze consistency degree or the facial expression similarity degree.

In the exemplary embodiment, the gaze information may include at least one of gaze direction information, pupil information, or eye movement information, and the processor may generate the gaze consistency degree on the basis of at least one of a similarity degree in gaze directions between the target user and the other user, a difference in pupil sizes between the target user and the other user, or a difference in eye movement speeds between the target user and the other user.

In the exemplary embodiment, the higher the similarity degree in the gaze directions is, the higher the gaze consistency degree may be, and the smaller the difference in the pupil sizes and the difference in the eye movement speeds are, the higher the gaze consistency degree may be.

In the exemplary embodiment, the face information may include movement information of facial muscles corresponding to at least one of a plurality of parts of a face, and the processor may generate the facial expression similarity degree on the basis of movement information of facial muscles.

In the exemplary embodiment, the processor may obtain position information between the target user and the other user from the movement information of each of the target user and the other user, generate a physical proximity degree and a movement similarity degree between the target user and the other user on the basis of the position information, and generate the physical empathy degree on the basis of at least one of the physical proximity degree or the movement similarity degree.

In the exemplary embodiment, the position information may include head position information of the target user and wrist position information of the users, and the processor may generate the physical proximity degree on the basis of at least one of a distance between a head position of the target user and a head position of the other user, or distances between wrist positions of the target user and wrist positions of the other user.

In the exemplary embodiment, the closer the distance between the head position of the target user and the head position of the other user is, the higher the physical proximity degree may be, and the closer the distances between the wrist positions of the target user and the wrist positions of the other user are, the higher the physical proximity degree may be.

In the exemplary embodiment, the position information may include head position information of the users and wrist position information of the users, and the processor may generate the movement similarity degree on the basis of a difference between a first center position relative to the head position and the both wrist positions of the target user and a second center position relative to the head position and the both wrist positions of the other user.

In the exemplary embodiment, the position information may include hand position information of the users, and the processor may generate the movement similarity degree on the basis of at least one of differences in positions of fingers between both of the target user and the other user, or differences in angles of finger joints between the target user and the other user.

In the exemplary embodiment, the display device may include a neural network model trained on the basis of a sample empathy degree responded by the target user for the other user and sample feature information comprising gaze information, face movement information, and position information which are obtained from training movement information and used to generate the final empathy degree, and the processor may generate the final empathy degree on the basis of weights of the neural network model.

According to a second aspect of the present disclosure as a technical means for solving the above-described technical problem, there is provided an electronic device, including: a memory for storing at least one instruction; and at least one processor, wherein the at least one processor may execute the at least one instruction, so as to receive first movement information for at least one body part of a first user responding to an extended reality (XR) image and second movement information for at least one body part of a second user responding to the extended reality image, obtain first feature information comprising gaze information, face information, and position information of the first user from the first movement information, obtain second feature information comprising gaze information, face information, and position information of the second user from the second movement information, obtain weights for pieces of the feature information by using a neural network model, and generate a final empathy degree of the first user for the second user on the basis of the first feature information, the second feature information, and the weights.

In an exemplary embodiment, the at least one processor may generate a gaze consistency degree between the first user and the second user on the basis of the gaze information of the first user and the gaze information of the second user, generate a facial expression similarity degree between the first user and the second user on the basis of the face information of the first user and the face information of the second user, and generate the final empathy degree on the basis of at least one of the gaze consistency degree or the facial expression similarity degree.

In the exemplary embodiment, the gaze information may include at least one of gaze direction information, pupil information, or eye movement information, and the at least one processor may generate the gaze consistency degree on the basis of at least one of a similarity degree in gaze directions between the first user and the second user, a difference in pupil sizes between the first user and the second user, and a difference in eye movement speeds between the first user and the second user.

In the exemplary embodiment, the face information may include movement information of facial muscles corresponding to at least one of a plurality of parts of a face, and the at least one processor may generate the facial expression similarity degree on the basis of the movement information of the facial muscles.

In the exemplary embodiment, the at least one processor may obtain the position information between the first user and the second user from the movement information of each of the first user and the second user, generate a physical proximity degree and a movement similarity degree between the first user and the second user on the basis of the position information, and generate the final empathy degree on the basis of at least one of the physical proximity degree or the movement similarity degree.

In the exemplary embodiment, the position information may include head position information of the users and wrist position information of the users, and the at least one processor may generate the physical proximity degree on the basis of at least one of a distance between a head position of the first user and a head position of the second user, or distances between wrist positions of the first user and wrist positions of the second user.

In the exemplary embodiment, the position information may include head position information, wrist position information, and hand position information of the users, and the at least one processor may generate the movement similarity degree on the basis of a difference between a first center position relative to the head position and the both wrist positions of the first user and a second center position relative to the head position and the both wrist positions of the second user, and a difference in angles of finger joints between of the first user and the second user.

According to a third aspect of the present disclosure as a technical means for solving the above-described technical problem, there is provided a wearable electronic device, including: a display panel for outputting an extended reality (XR) image to users; a sensing unit for obtaining first movement information about at least one body part of a first user responding to the extended reality image; a communication unit for receiving second movement information about at least one body part of a second user responding to the extended reality image; and a processor for calculating an emotional empathy degree and a physical empathy degree of the first user for the second user on the basis of the first movement information and the second movement information and generating a final empathy degree of the first user for the second user on the basis of the emotional empathy degree and the physical empathy degree.

According to a fourth aspect of the present disclosure as a technical means for solving the above-described technical problem, there is provided an operating method of an electronic device, the operating method including: obtaining first movement information for at least one body part of a first user responding to an extended reality (XR) image and second movement information for at least one body part of a second user responding to the extended reality image; obtaining first feature information comprising gaze information, face information, and position information of the first user from the first movement information, and obtaining second feature information comprising gaze information, face information, and position information of the second user from the second movement information; obtaining weights for pieces of the feature information by using a neural network model; and generating a final empathy degree of the first user for the second user on the basis of the first feature information, the second feature information, and the weights

The embodiment of the present disclosure may calculate an emotional empathy degree and a physical empathy degree of a user by using movement information of the user responding through an extended reality (XR) image, and generate a final empathy degree of the user on the basis of the emotional empathy degree and the physical empathy degree. The embodiment of the present disclosure uses the movement information of the user responding through the extended reality (XR) image, so that the final empathy degree of the user may be measured multidimensionally and with high accuracy even without using signals obtained from other devices rather than using the movement information obtainable from a HMD wearable device.

The effects that may be obtained from the exemplary embodiments of the present disclosure are not limited to the above-described effects, and other effects that are not described above will be clearly derived and understood from the following description by those skilled in the art to which the exemplary embodiments of the present disclosure belongs. That is, unintended effects resulting from implementing the exemplary embodiments of the present disclosure may also be derived by those skilled in the art from the exemplary embodiments of the present disclosure.

### BRIEF DESCRIPTION OF THE DRAWINGS

FIG. 1 is a block diagram illustrating a display system according to an exemplary embodiment of the present disclosure.

FIG. 2 is a view illustrating an extended reality environment according to the exemplary embodiment of the present disclosure.

FIG. 3 is a view illustrating a gaze consistency degree according to the exemplary embodiment of the present disclosure.

FIG. 4 is a view illustrating a facial expression similarity degree according to the exemplary embodiment of the present disclosure.

FIG. 5 is a view illustrating a physical proximity degree according to the exemplary embodiment of the present disclosure.

FIG. 6 is a view illustrating a movement similarity degree according to the exemplary embodiment of the present disclosure.

FIG. 7 is a view illustrating learning of a segmentation neural network model according to the exemplary embodiment of the present disclosure.

FIG. 8 is a flowchart illustrating an operating method of an electronic device according to an exemplary embodiment of the present disclosure.

FIG. 9 is a block diagram illustrating the electronic device according to the exemplary embodiment of the present disclosure.

FIG. 10 is a view illustrating a wearable device system according to an exemplary embodiment of the present disclosure.

FIG. 11 is a block diagram illustrating a wearable electronic device according to the exemplary embodiment of the present disclosure.

### DETAILED DESCRIPTION OF THE INVENTION

The terms used in the present exemplary embodiments have selected general terms that are currently widely used as possible while considering functions in the present exemplary embodiments, but this may vary depending on intention of those skilled in the art, precedents, emergence of new technologies, etc. In addition, in certain cases, there are terms arbitrarily selected by the applicant, and in this case, the meaning of the terms will be described in detail in the description of the corresponding parts. Therefore, the terms used in the present exemplary embodiments should be defined on the basis of the meanings of the terms and the overall contents of the present exemplary embodiments rather than based on simple names of the terms.

The present exemplary embodiments may be modified in various ways and may take many forms, so some exemplary embodiments will be illustrated in the drawings and described in detail. However, this is not intended to limit the present exemplary embodiments to a particular disclosed form. On the contrary, the present disclosure is to be understood to include all various alternatives, equivalents, and substitutes that may be included within the idea and technical scope of the present exemplary embodiments. The terms used in the present specification are merely used to describe the exemplary embodiments and are not intended to limit the present exemplary embodiments.

The terms used in the present exemplary embodiments have the same meanings as commonly understood by those skilled in the art to which the present exemplary embodiments belong, unless otherwise defined. It will be further understood that terms as defined in dictionaries commonly used herein should be interpreted as having meanings that are consistent with their meanings in the context of the relevant art and should not be interpreted in an idealized or overly formal sense unless expressly so defined in the present exemplary embodiments.

Some exemplary embodiments of the present disclosure may be represented by functional block components and various processing steps. Some or all of these functional blocks may be implemented in various numbers of hardware and/or software components that perform specific functions. For example, the functional blocks of the present disclosure may be implemented by one or more microprocessors, or may be implemented by circuit components for certain functions. In addition, for example, the functional blocks of the present disclosure may be implemented in various programming or scripting languages. The functional blocks may be implemented as algorithms that are executed on one or more processors. In addition, the present disclosure may employ conventional technologies for electronic environment setup, signal processing, and/or data processing.

In addition, terms including ordinal numbers such as “first” or “second” used in the present specification may be used to describe various components, but the components should not be limited by the terms. The above terms may be used for the purpose of distinguishing one component from another component.

In addition, connection lines or connection members between components shown in the drawings merely exemplify functional connections and/or physical or circuit connections. In an actual device, connections between components may be represented by various replaceable or additional functional connections, physical connections, or circuit connections.

Hereinafter, the exemplary embodiments of the present disclosure will be described in detail with reference to the attached drawings.

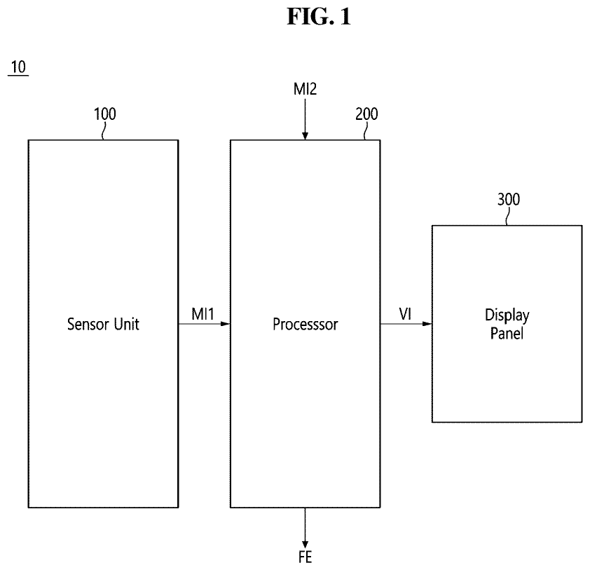

FIG. 1 is a block diagram illustrating a display system according to an exemplary embodiment of the present disclosure.

The display system 10 according to the exemplary embodiment of the present disclosure may be mounted on an electronic device having an image display function. For example, the electronic device may include smartphones, tablet personal computers, portable multimedia players (PMPs), cameras, wearable devices, televisions, digital video disk (DVD) players, refrigerators, air conditioners, air purifiers, set-top boxes, robots, drones, various medical devices, navigation devices, global positioning system (GPS) receivers, vehicle devices, furniture, various measuring devices, or the like. Referring to FIG. 1, the display system 10 may include a sensing unit 100, a processor 200, and a display panel 300. Depending on the exemplary embodiments, the display system 10 may further include other general-purpose components in addition to the components shown in FIG. 1. In the display system 10, the sensing unit 100 and the processor 200 may also be referred to as a display device.

The sensing unit 100 may obtain movement information MI1 about at least one of body parts of a target user. The sensing unit 100 may obtain the movement information MI1 of the target user responding to an extended reality (XR) image. A plurality of users may be connected to an extended reality environment, and a particular user may interact with other users. The extended reality environment may include virtual reality (VR) for utilizing closed HMDs such as Meta Quest and HTC VIVE, augmented reality (AR) for utilizing open HMDs such as Microsoft Hololens, and mixed reality (MR). The target user is a user who uses the display system 10 and may refer to a user who is a subject of empathy degree measurement.

The sensing unit 100 may include a plurality of sensors. For example, the sensing unit 100 may include an inertial measurement unit (IMU) sensor, an infrared ray (IR) sensor, an RGB sensor, an image sensor, etc. The sensing unit 100 may obtain movement information MI1 of a target user by using the above sensors.

The processor 200 may generate a final empathy degree FE of the target user. The final empathy degree FE may be a value obtained by quantifying a degree of empathy of the target user for another user accessing an extended reality image. The processor 200 may generate the final empathy degree FE on the basis of movement information MI1 of the target user. The processor 200 may also receive movement information MI2 of the other user. Exemplarily, the movement information MI2 of the other user may be transmitted to a display device of the target user through communication with a display device of the other user.

For example, the display device may communicate with a display device of the other user through any wired or wireless communication systems including: one or more of Ethernets, telephones, cables, power-lines, and fiber optic systems and/or one or more code division multiple access (CDMA or CDMA2000) communication systems; a frequency division multiple access (FDMA) system; an orthogonal frequency division multiplexing (OFDM) access system; a time division multiple access (TDMA) system such as a global system for mobile communications (GSM); a general packet radio service (GPRS) or enhanced data GSM environment (EDGE) system; a terrestrial trunked radio (TETRA) mobile telephone system; a wideband code division multiple access (WCDMA) system; a high-speed data rate 1×EV-DO (for first generation evolution data only) or 1×EV-DO gold multicast system; and an IEEE 802.18 system, a DMB system, a DVB-H system, or wireless systems including any other methods for data communication between two or more devices. However, the communication systems are not necessarily limited to the examples listed above.

The processor 200 may generate a final empathy degree FE on the basis of the movement information MI1 of the target user and the movement information MI2 of the other user. The processor 200 may generate the final empathy degree FE on the basis of an emotional empathy degree and a physical empathy degree. The emotional empathy degree may mean a degree to which a physiological response generated depending on a target user's degree of empathy for another user is explicitly expressed in terms of gaze and facial expressions. The processor 200 may calculate the emotional empathy degree on the basis of the movement information MI1 and the movement information MI2. Exemplarily, the processor 200 may obtain gaze information and face information of the target user and another user from the movement information MI1 and movement information MI2, and generate the emotional empathy degree on the basis of the gaze information and the face information.

The physical empathy degree may refer to a degree to which a physiological response generated depending on the target user's degree of empathy for another user is explicitly expressed in terms of physical distances and movements. The processor 200 may calculate the physical empathy degree on the basis of the movement information MI1 and the movement information MI2. Exemplarily, the processor 200 may obtain position information of the target user and the other user from the respective movement information MI1 and movement information MI2, and generate the physical empathy degree on the basis of the position information. Specifically, a final empathy degree FE may be expressed as Equation 1 below. However, Equation 1 may also correspond to an example for calculating the final empathy degree FE.

$$FE = Ve + Vm \qquad [ Equation 1 ]$$

Here, Ve may mean an emotional empathy degree, and Vm may mean a physical empathy degree.

According to the exemplary embodiment, the processor 200 may include a data processing device, which is capable of processing data, such as a central processing unit (CPU), a graphical processing unit (GPU), a processor, or a microprocessor. The processor 200 may control the overall operation of the display system 10.

The processor 200 may generate a virtual user image VI from movements of the target user on the basis of the movement information MI1. The virtual user image VI may be generated as an extended reality image. Exemplarily, the processor 200 may use the movement information MI1 to generate the virtual user image VI so that the target user is represented as an avatar in a VR environment. Exemplarily, the processor 200 uses the movement information MI1 to generate the virtual user image VI so that the target user is represented in a form where a virtual object is combined with and augmented on the target user's body or a projected image in an AR or MR environment. The processor 200 may generate the extended reality image from the movements of the target user and display the extended reality image on the display panel 300.

The display panel 300 may display an image on the basis of the virtual user image VI. The display system 10 may display the virtual user image VI to the target user through the display panel 300. The display panel 300 may display an extended reality environment to the user, and also display the virtual user image VI representing the target user and an extended reality image representing the other user.

The display panel is a display unit on which an actual image is displayed, and may be one of display devices, which display a two-dimensional image by receiving an input of electrically transmitted image signals, such as a thin film transistor-liquid crystal display (TFT-LCD), an organic light emitting diode (OLED) display, a field emission display, and a plasma display panel (PDP). The display panel may be implemented as another type of flat display or flexible display panel.

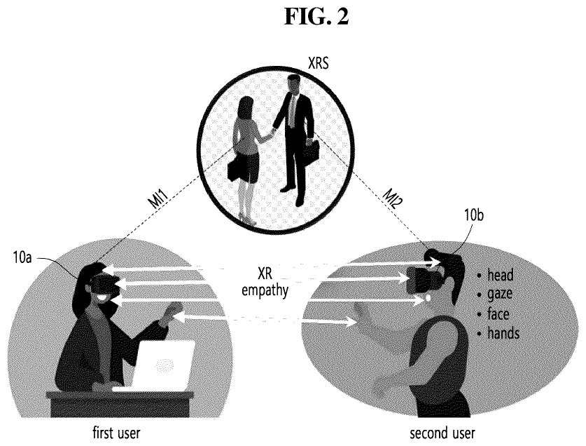

FIG. 2 is a view illustrating an extended reality environment according to the exemplary embodiment of the present disclosure. A first display device 10a and second display device 10b in FIG. 2 may be applied to the display system 10 in FIG. 1. Content redundant with the above-described content is omitted.

Referring to FIG. 2, a first user wears the first display device 10a, and a second user wears the second display device 10b. Relative to the first display device 10a, the first user may correspond to a target user, and the second user may be the other user. Based on the second display device 10b, the second user may correspond to the target user, and the first user may be the other user. Hereinafter, it is assumed that the first user is the target user.

The first user and the second user may connect to an extended reality environment XRS. The first user may interact with the second user in the extended reality environment XRS. FIG. 2 shows that the two users access the extended reality environment XRS, but it is not necessarily limited thereto, and varying number of users may connect to the extended reality environment XRS.

The first display device 10a may obtain movement information MI1 of the first user (hereinafter referred to as first movement information), and use the first movement information MI1 to display the first user's movements as a virtual user image, i.e., an extended reality image, on the extended reality environment XRS. The second display device 10b may obtain movement information MI2 of the second user (hereinafter referred to as second movement information), and use the second movement information MI2 to display the second user's movements as a virtual user image, i.e., an extended reality image on the extended reality environment XRS.

The first display device 10a may obtain first feature information including at least one of the gaze information, face information, and position information of the first user from the first movement information MI1. The position information may include head position information, wrist position information, and hand position information of the first user. The second display device 10b may obtain second feature information including at least one of gaze information, face information, and position information of the second user from the second movement information MI2. The position information may include head position information, wrist position information, and hand position information of the second user.

The first display device 10a may calculate an emotional empathy degree and a physical empathy degree of the first user for the second user on the basis of the first feature information and the second feature information. The first display device 10a may generate a final empathy degree on the basis of the emotional empathy degree and the physical empathy degree. In the exemplary embodiment, the first display device 10a may calculate the emotional empathy degree on the basis of at least one of the gaze information and face information. Exemplarily, the first display device 10a may generate a gaze consistency degree between the first user and the second user by using the gaze information of the first user and the gaze information of the second user.

Exemplarily, the first display device 10a may generate a facial expression similarity degree between the first user and the second user by using the face information of the first user and the face information of the second user. The first display device 10a may generate an emotional empathy degree on the basis of at least one of the gaze consistency degree and the facial expression similarity degree.

The emotional empathy degree may be expressed by Equation 2 below. Equation 2 may also correspond to an example for calculating the emotional empathy degree.

$$Ve = Sg + Sf \qquad [ Equation 2 ]$$

Here, Ve may mean an emotional empathy degree, Sg may mean a gaze consistency degree, and Sf may mean a facial expression similarity degree.

In the exemplary embodiment, the first display device 10a may calculate an emotional empathy degree on the basis of position information. Exemplarily, the first display device 10a may generate a physical proximity degree between the first user and the second user by using the position information of the first user and the position information of the second user.

Exemplarily, the first display device 10a may generate a movement similarity degree between the first user and the second user by using the position information of the first user and the position information of the second user. The first display device 10a may generate a physical empathy degree on the basis of at least one of the physical proximity degree and the movement similarity degree.

The physical empathy degree may be expressed by Equation 3 below. Equation 3 may correspond to an example for calculating the physical empathy degree.

$$Vm = Sb + Sm \qquad [ Equation 3 ]$$

Here, Vf may mean a physical empathy degree, Sb may mean a physical proximity degree, and Sm may mean a movement similarity degree.

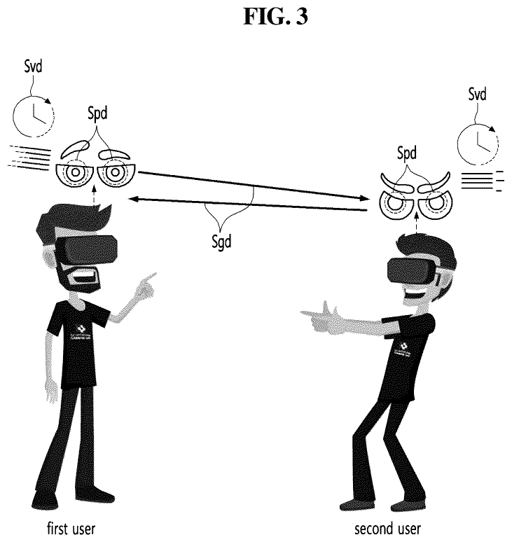

FIG. 3 is a view illustrating a gaze consistency degree according to the exemplary embodiment of the present disclosure. Specifically, the processor 200 of FIG. 1 may generate the gaze consistency degree. Content redundant with the above-described content is omitted.

The processor may obtain gaze information, which is feature information of the first user, from the first movement information, and obtain gaze information of the second user from the second movement information. The processor may generate a gaze consistency degree between the first user and the second user by using the gaze information of the first user and the gaze information of the second user. Exemplarily, the gaze information may be provided from a pupil recording device attached to a display device.

In the exemplary embodiment, gaze information may include at least one of gaze direction information, pupil information, and eye movement information. The processor may calculate a gaze consistency degree on the basis of at least one of the gaze direction information, pupil information, and eye movement information of each of the first user and the second user.

The processor may calculate a similarity degree in gaze directions between the first user and the second user on the basis of the gaze direction information of the first user and the gaze direction information of the second user. The processor may calculate a difference in pupil sizes between the first user and the second user on the basis of the pupil information of the first user and the pupil information of the second user. The processor may calculate a difference in eye movement speeds between the first user and the second user on the basis of the eye movement information of the first user and the eye movement information of the second user.

In the exemplary embodiment, the processor may generate a gaze consistency degree on the basis of at least one of the similarity degree in gaze directions between the first user and the second user, the difference in pupil sizes between the user and the other user, and the difference in eye movement speeds between the user and the other user. The processor may calculate the gaze consistency degree based on Equation 4 below.

$$Sg = ( wgd \times Sgd ) + ( wpd \times Spd ) + ( wvd \times Svd ) \qquad [ Equation 4 ]$$

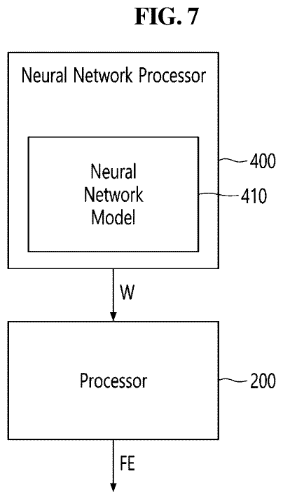

Here, Sg may mean a gaze consistency degree, Sgd may mean a gaze direction feature value, Spd may mean a pupil feature value, and Svd may mean an eye movement speed feature value. Here, wgd, wpd, and wvd may mean respective weights for the gaze direction feature value, pupil feature value, and eye movement speed feature value. Depending on the weights wgd, wpd, and wvd, a proportion of each feature value for calculating the gaze consistency degree Sg may vary. The weights wgd, wpd, and wvd may also be preset, or may also be set by using a neural network model as described in FIG. 7.

A gaze direction feature value Sgd is a value representing how similar a gaze direction of the first user is to a gaze direction of the second user. The gaze direction feature value Sgd may be one of feature values for calculating a final empathy degree. The processor may calculate the gaze direction feature value Sgd on the basis of the gaze direction information of the first user and the gaze direction information of the second user. The processor may calculate the gaze direction feature value Sgd on the basis of a similarity degree in gaze directions between the first user and the second user. The processor may calculate the gaze direction feature value Sgd based on Equation 5 below.

$${S}_{gd} = \frac{- {C}_{gazeCOS} ( i , j ) + 1}{2} \qquad [ Equation 5 ]$$

Here, i may mean a first user (e.g., a target user), j may mean a second user (e.g., the other user), and C_{gazeCOS}(i, j) may mean a cosine similarity degree in gaze directions between the first user and the second user. Exemplarily, in a case of a direction in which the first user and the second user face each other, a gaze direction feature value Sgd may increase. In a case of a direction in which the first user and the second user face each other's backs, a gaze direction feature value Sgd may decrease. Exemplarily, the more gaze directions between the first user and the second user are similar to each other, the higher a gaze consistency degree Sg may be.

A pupil feature value Spd is a value representing a difference between a pupil size of the first user and a pupil size of the second user. The pupil feature value Spd may be one of feature values for calculating a final empathy degree. The processor may calculate the pupil feature value Spd on the basis of pupil information of the first user and pupil information of the second user. The processor may calculate the pupil feature value Spd on the basis of a difference in pupil diameters between the first user and the second user. The processor may calculate the pupil feature value Spd based on Equation 6 below.

$${S}_{pd} = EXP ( - \frac{{C}_{pupildif} ( i , j )}{{τ}_{pd}} ) \qquad [ Equation 6 ]$$

Here, i may mean a first user (e.g., a target user), j may mean a second user (e.g., the other user), and C_{pupildif}(i, j) may mean a difference in pupil diameters between the first user and the second user. Here, τ_{pd} may be a hyper parameter for adjusting scale and outliers of the pupil feature value Spd. Exemplarily, the smaller a difference in pupil diameters between the first user and the second user, the higher a gaze consistency degree Sg may be.

An eye movement speed feature value Svd is a value representing a difference between an eye movement speed of the first user and an eye movement speed of the second user. The eye movement speed feature value Svd may be one of feature values for calculating a final empathy degree. The processor may calculate the eye movement speed feature value Svd on the basis of eye movement information of the first user and eye movement information of the second user. The processor may calculate the eye movement speed feature value Svd on the basis of a difference in average eye movement speeds between the first user and the second user. The processor may calculate the eye movement speed feature value Svd based on Equation 7 below.

$${S}_{vd} = EXP ( - \frac{{C}_{veldif} ( i , j , N )}{{τ}_{vd}} ) \qquad [ Equation 7 ]$$

Here, i may mean a first user (e.g., a target user), j may mean a second user (e.g., the other user), and C_veldif (i, j, N) may mean a difference in average eye movement speeds between the first user and the second user for N seconds. Here, τ_{vd} may be a hyper parameter for adjusting scale and outliers of the eye movement speed feature value Svd equation. Exemplarily, the smaller a difference in average eye movement speeds between the first user and the second user, the higher a gaze consistency degree Sg may be.

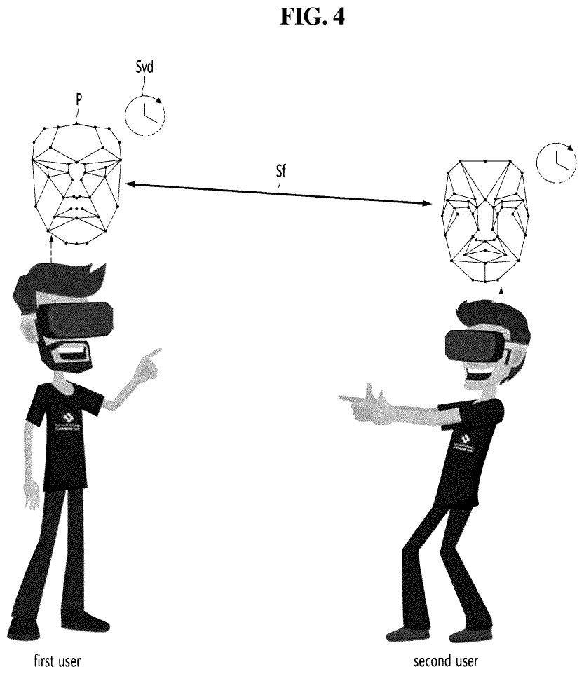

FIG. 4 is a view illustrating a facial expression similarity degree according to the exemplary embodiment of the present disclosure. Specifically, the processor 200 of FIG. 1 may generate the facial expression similarity degree. Content redundant with the above-described content is omitted.

The processor may obtain face information, which is feature information of the first user, from first movement information, and obtain face information of the second user from second movement information. The processor may generate a facial expression similarity degree between the first user and the second user by using the face information of the first user and the face information of the second user. Exemplarily, gaze information may be provided from a pupil & face recording device attached to a display device. However, it is not necessarily limited thereto.

In the exemplary embodiment, the face information may include movement information of facial muscles corresponding to at least one of a plurality of parts of a user's face. However, it is not necessarily limited thereto, and the face information may include a movement angle and the like of the at least one of the plurality of parts of the user's face. The processor may calculate a facial expression similarity degree on the basis of movement information of facial muscles of each of the first user and the second user.

The processor may calculate facial feature values between the first user and the second user on the basis of the movement information of the facial muscles of the first user and the movement information of the facial muscles of the second user. The processor may generate a facial expression similarity degree by using the facial feature values. The processor may calculate the facial expression similarity degree based on Equation 8 below.

$${S}_{f} = {w}_{f} \cdot \frac{1}{M} {\sum }_{k = 1}^{M} \frac{{C}_{faceNCC} ( i , j , k , N ) + 1}{2} \qquad [ Equation 8 ]$$

Here, Sf may mean a facial expression similarity degree, and C_{faceNCC}(i, j, k, N) may mean each facial feature value. The facial expression similarity degree Sf may be calculated by adding up all M facial feature values C_{faceNCC}(i, j, k, N) for N seconds. Here, wf may mean a weight for the face feature values C_{faceNCC}(i, j, k, N), and a weight wgf may be preset or may be set by using the neural network model as described in FIG. 7.

Each facial feature value C_{faceNCC}(i, j, k, N) is a value representing how similar a facial expression of the first user is to a facial expression of the second user, and each facial feature value C_{faceNCC}(i, j, k, N) may be one of feature values for calculating a final empathy degree. The processor may calculate each facial feature value C_{faceNCC}(i, j, k, N) on the basis of the movement information of the facial muscles of the first user and the movement information of the facial muscles of the second user.

Exemplarily, the processor may calculate facial feature values C_{faceNCC}(i, j, k, N) by using action unit values of a facial action coding system (FACS). Action unit values represent degrees of facial muscle movements relative to facial points p of a user and may be expressed as a value between 0 and 1. Each face feature value C_{faceNCC}(i, j, k, N) refers to synchronization values of action unit values between the first user and the second user, and may be normalized cross-correlation (NCC) values for action unit values of the first user and action unit values of the second user. The processor may calculate the facial feature values C_{faceNCC}(i, j, k, N) based on Equation 9 below.

$${C}_{faceNCC} ( i , j , k , N ) = {C}_{NCC} ( \vert {C}_{actunit} ( i , k ) - {C}_{actunit} ( j , k ) \vert , N ) \qquad [ Equation 9 ]$$

Here, i may mean a first user (e.g., a target user), j may refer to a second user (e.g., the other user), and C_{actunit} may mean action unit values.

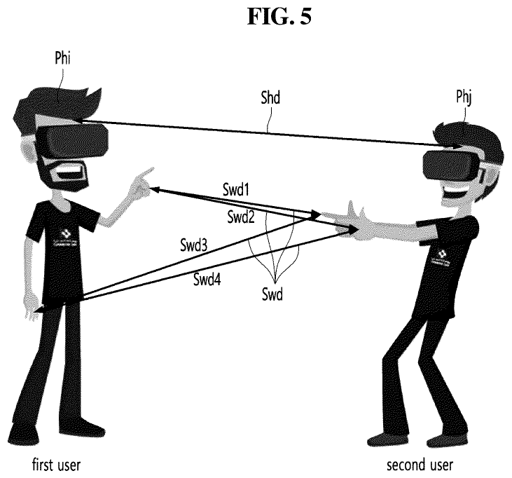

FIG. 5 is a view illustrating a physical proximity degree according to the exemplary embodiment of the present disclosure. Specifically, the processor 200 of FIG. 1 may generate the physical proximity degree. Content redundant with the above-described content is omitted.

The processor may obtain position information, which is feature information of the first user, from the first movement information, and obtain position information of the second user from the second movement information. The processor may generate a physical proximity degree between the first user and the second user by using the position information of the first user and the position information of the second user. Exemplarily, the position information may be each user's body coordinate absolute values expressed in the extended reality environment.

In the exemplary embodiment, the position information may include at least one of head position information of a user and wrist position information of the user. The processor may calculate a physical proximity degree on the basis of at least one of the head position information and wrist position information of each of the first user and second user.

The processor may calculate a distance between respective head positions of the first user and second user on the basis of the head position information of the first user and the head position information of the second user. The processor may calculate distances between wrist positions of the first user and second user on the basis of the wrist position information of the first user and the wrist position information of the second user.

In the exemplary embodiment, the processor may generate a physical proximity degree on the basis of at least one of a distance between the head position of the first user and the head position of the second user and distances between the wrist positions of the first user and the wrist positions of the second user. The processor may calculate the physical proximity degree based on Equation 10 below.

$$Sb = ( whd \times Shd ) + ( wwd \times Swd ) \qquad [ Equation 10 ]$$

Here, Sb may mean a physical proximity degree, Shd may mean a head position feature value, and Swd may mean a wrist position feature value. Here, whd and wwd may mean respective weights for the head position feature value and wrist position feature value. Depending on the weights whd and wwd, a proportion of each feature value for calculating a physical proximity degree Sb may vary. The weights whd and wwd may be preset or may be set by using the neural network model as described in FIG. 7.

A head position feature value Shd is a value representing a distance between a head position of the first user and a head position of the second user, and the head position feature value Shd may be one of feature values for calculating a final empathy degree. The processor may calculate the head position feature value Shd on the basis of head position coordinates phi of the first user and head position coordinates phj of the second user. The head position coordinates phi and phj of the users may be coordinates of specific positions on heads of the users. The processor may calculate the head position feature value Shd on the basis of a distance between the respective head position coordinates phi and phj of the first user and the second user. The processor may calculate the head position feature value Shd based on Equation 11 below.

$${S}_{hd} = exp ( - \frac{{C}_{headdist} ( i , j )}{{τ}_{hd}} ) \qquad [ Equation 11 ]$$

Here, i may mean a first user (e.g., a target user), j may mean a second user (e.g., the other user), and C_{headdist}(i, j) may mean a distance between respective head positions of the first user and second user. Here, τ_{hd} may be a hyper parameter for adjusting scale and outliers of the head position feature value Shd. Exemplarily, the closer a distance between the head position of the first user and the head position of the second user is, the higher a physical proximity degree Sb may be.

A wrist position feature value Swd is a value representing distances between wrist positions of the first user and wrist positions of the second user, and the wrist position feature value Swd is one of feature values for calculating a final empathy degree. The processor may calculate the wrist position feature value Swd on the basis of both wrist positions of the first user and both wrist positions of the second user. The wrist position feature value Swd may be calculated on the basis of a combination of positions of all wrists of the first user and the second user.

For example, the processor may calculate a first wrist position feature value swd1 on the basis of a position of the left wrist of the first user and a position of the left wrist of the second user, calculate a second wrist position feature value swd2 on the basis of a position of the left wrist of the first user and a position of the right wrist of the second user, calculate a third wrist position feature value swd3 on the basis of a position of the right wrist of the first user and a position of the left wrist of the second user, and calculate a fourth wrist position feature value swd4 on the basis of a position of the right wrist of the first user and a position of the right wrist of the second user. Exemplarily, the processor may generate the wrist position feature value swd by adding up the first wrist position feature value swd1, the second wrist position feature value swd2, the third wrist position feature value swd3, and the fourth wrist position feature value swd4. The processor may calculate the wrist position feature value Swd based on Equation 12 below.

$${S}_{wd} = \frac{1}{H} {\sum }_{k = 1}^{H} exp ( - \frac{{C}_{wristdist} ( i , j , k )}{{τ}_{wd}} ) \qquad [ Equation 12 ]$$

Here, i may mean a first user (e.g., a target user), j may mean a second user (e.g., the other user), and C_{wristdist}(i, j, k) may mean distances between wrist positions between the first user and the second user. Here, k may mean the number of cases for wrist position combinations, and τ_{wd} may be a hyper parameter for adjusting scale and outliers of the wrist position feature value Swd. Exemplarily, the closer distances between wrist positions of the first user and wrist positions of the second user are, the higher a physical proximity degree Sb may be.

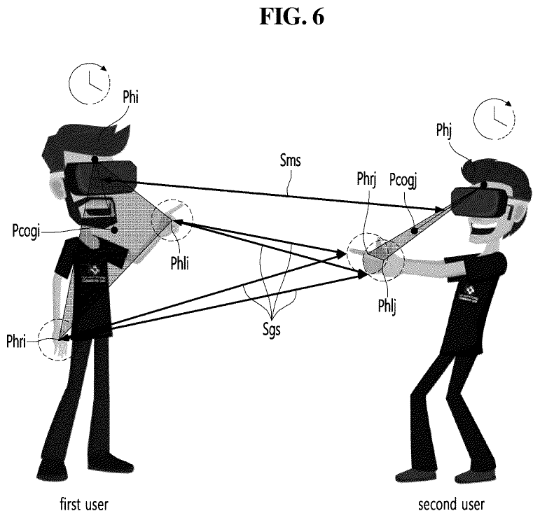

FIG. 6 is a view illustrating a movement similarity degree according to the exemplary embodiment of the present disclosure. Specifically, the processor 200 of FIG. 1 may generate the movement similarity degree. Content redundant with the above-described content is omitted.

The processor may obtain position information, which is feature information of the first user, from first movement information, and obtain position information of the second user from second movement information. The processor may generate a movement similarity degree between the first user and the second user by using the position information of the first user and the position information of the second user. Exemplarily, the position information may be each user's body coordinate absolute values expressed in the extended reality environment.

In the exemplary embodiment, the position information may include at least one of head position information, wrist position information, and hand position information of the users. The processor may calculate a movement similarity degree on the basis of at least one of the head position information, wrist position information, and hand position information of each of the first user and the second user.

The processor may calculate a similarity degree of the overall body movements of the first user and the second user on the basis of the head position information of each of the first user and second user and the wrist position information of each of the first user and second user. The processor may calculate a similarity degree between hand position information of the first user and hand position information of the second user. The processor may calculate a physical proximity degree based on Equation 13 below.

$$Sm = ( wms \times Sms ) + ( wgs \times Sgs ) \qquad [ Equation 13 ]$$

Here, Sm may mean a movement similarity degree, Sms may mean a body movement feature value, and Sgs may mean a hand gesture feature value. Here, wms and wgs may mean respective weights for the body movement feature value and hand gesture feature value. Depending on the weights wms and wgs, a proportion of each feature value for calculating the movement similarity degree Sm may vary. The weights wms and wgs may be preset or may be set by using the neural network model as described in FIG. 7.

A body movement feature value Sms is a value representing a similarity degree of the overall body movements of the first user and the second user, and the body movement feature value Sms may be one of feature values for calculating a final empathy degree. The processor may calculate the body movement feature value Sms on the basis of head position coordinates phi and wrist position coordinates phri and phrli of the first user, and head position coordinates phj and wrist position coordinates phrj and phlj of the second user. The processor may calculate the body movement feature value Sms on the basis of a difference between a center position relative to a head position and both wrist positions of the first user and a center position relative to a head position and both wrist positions of the second user. The processor may calculate the body movement feature value Sms based on Equation 14 below.

$${S}_{ms} = \frac{{C}_{moveNCC} ( i , j , N ) + 1}{2} \qquad [ Equation 14 ]$$

$${C}_{moveNCC} ( i , j , N ) = {C}_{NCC} ( exp ( - \frac{\vert {C}_{move} ( i ) - {C}_{move} ( j ) \vert}{{τ}_{ms}} ) , N ) ,$$

$${C}_{move} = \vert {P}_{head} - {P}_{COG} \vert$$

Here, i may mean a first user (e.g., a target user), j may mean a second user (e.g., the other user), and C_{moveNCC}(i, j, N) may mean degrees of similarity of body movements between the first user and the second user. Cₘₒᵥₑ may represent body movements of each user. Here, τₘₛ may be a hyper parameter for adjusting scale and outliers of the body movement feature value Sms.

A value of body movement Cₘₒᵥₑ of a user may be calculated as a difference between head position coordinate values of the user and center position coordinate values of the user. Exemplarily, center-of-gravity coordinate values may be center-of-gravity coordinate values of a triangle drawn along the head, left hand, and right hand of the user. For example, a first center position Pcogi of the first user may be center-of-gravity coordinate values of a head position coordinate value Phi, left hand position coordinate value phli, and right hand position coordinate value phri of the first user. A second center position Pcogj of the second user may be center-of-gravity coordinate values of a head position coordinate value Phj, left hand position coordinate value phlj, and right hand position coordinate value phrj of the second user. The processor may calculate C_{moveNCC}(i, j, N) by adding up synchronization values between the two users for the body movement Cₘₒᵥₑ values of the users for N seconds.

A hand gesture feature value Sgs is a value representing a hand gesture similarity degree of each of the first user and the second user, and the hand gesture feature value Sgs may be one of feature values for calculating a final empathy degree. The processor may calculate the hand gesture feature value Sgs on the basis of hand position information of the first user and hand position information of the second user. Exemplarily, the hand position information may include finger position information, finger joint angle information, etc. The processor may generate the hand gesture feature value Sgs on the basis of at least one of the finger position information and finger joint angle information of the first user and second user.

In the exemplary embodiment, the processor may calculate a hand gesture feature value Sgs on the basis of a difference in angles of finger joints matching each other between the first user and the second user. The processor may calculate the hand gesture feature value Sgs based on Equation 15 below.

$${S}_{gs} = \frac{1}{HJ} {\sum }_{l = 1}^{J} {\sum }_{k = 1}^{H} \frac{{C}_{gestureNCC} ( i , j , k , l , N ) + 1}{2} , \qquad [ Equation 15 ]$$

$${C}_{gestureNCC} ( i , j , k , l , N ) = {C}_{NCC} ( exp ( - \frac{{C}_{angdist} ( i , j , k , l )}{{τ}_{gs}} ) , N ) .$$

Here, i may mean a first user (e.g., a target user), j may mean a second user (e.g., the other user), and C_{gestureNCC}(i, j, k, l, N) may mean degrees of hand gesture similarity between the first user and the second user. C_{angdist} may represent a difference in angles of finger joints matching each other of the first user and the second user. Here, τ_{gs} may be a hyper parameter for adjusting scale and outliers of the hand gesture feature value Sgs.

Since a hand gesture feature value Sgs causes a user's right hand to imitate the other user's left hand gesture and the user's left hand to imitate the other user's right hand gesture, the processor may generate the hand gesture feature value Sgs by adding up differences in angles of the finger joints for H cases, which are all combinations of the hands (e.g., left versus left hand, left versus right hand, right versus left hand, and right versus right hand). The processor may generate the hand gesture feature value Sgs on the basis of the differences in angles of the finger joints for the total of H combinations of the hands and the total of J joints for N seconds.

In the present disclosure, the feature values may be calculated by using the movement information of the user responding through the extended reality (XR) image. The final empathy degree of the user may be generated by using the feature values. The embodiment of the present disclosure may measure the user's final empathy degree multidimensionally and with high accuracy by using the movement information of the user responding through the extended reality (XR) image even without using signals obtained from other devices.

FIG. 7 is a view illustrating learning of a neural network model according to the exemplary embodiment of the present disclosure. A display device 10a of FIG. 7 may further include a neural network model 410. Content redundant with the above-described content is omitted.

Referring to FIG. 7, the display device 10a may include a neural network processor 400 and a processor 200. The neural network processor 400 may receive input data, perform an operation based on the neural network model 410, and provide output data based on the operation results. The neural network model 410 may update a weight w through training, and the weight w of the neural network model 410 may be used as a weight w of each feature value to generate a final empathy degree.

The neural network processor 400 may generate the neural network model 410, perform training or learning of the neural network model 410, perform an operation based on received input data, generate information signals based on the performed operation results, or perform retraining of the neural network model 410. An NNP 13 is capable of processing operations based on various types of networks such as a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) network, and a classification network. However, the NNP 13 is not limited thereto, and is capable of processing various types of operations that mimic human neural networks.

The neural network processor 400 may include one or more processors to perform operations according to the neural network models. In addition, the neural network processor 400 may also include a separate memory for storing programs corresponding to the neural network models. The neural network processor 400 may be differently referred to as a neural network processing device, a neural network integrated circuit, a neural network processing unit (NPU), or the like.

The neural network processor 400 may generate output data by performing a neural network operation on input data on the basis of the neural network model 410, and the neural network operation may include a convolution operation. To this end, the neural network processor 400 may learn the neural network model 410.

The neural network model 410 may be generated by training in a learning device (e.g., a server configured to learn a neural network on the basis of a large volume of input data), and the trained neural network model 410 may be executed by the neural network processor 400. However, it is not necessarily limited thereto, and the neural network model 410 may also be learned in the neural network processor 400.

The neural network model 410 may perform learning on the basis of sample feature information and a sample empathy degree. Input data of the neural network model 410 may be the sample feature information, and output data may be the sample empathy degree responded by a first user for a second user. The sample feature information may include gaze information, face information, and position information, which are used to generate a final empathy degree and obtained from training movement information. The sample empathy degree may be a degree of empathy directly responded by a user, who generated the training movement information, for the other user. The neural network model 410 may be trained on the basis of supervised learning with the sample feature information set as an input and the sample empathy degree set as a correct answer.

The processor 200 may receive weights w of the neural network model 410 and generate a final empathy degree on the basis of the weights w. For example, the processor may receive, from the neural network processor 400, a weight (e.g., a weight wgd in FIG. 3) for a gaze direction feature value (e.g., a gaze direction feature value Sgd in FIG. 3), a weight (e.g., a weight wpd in FIG. 3) for a pupil feature value (e.g., a pupil feature value Spd in FIG. 3), and a weight (e.g., a weight wvd in FIG. 3) for an eye movement speed feature value (e.g., an eye movement speed feature value Svd in FIG. 3). The processor 200 may generate a gaze consistency degree on the basis of the gaze direction feature value Sgd, the pupil feature value Spd, the eye movement speed feature value Svd, the weight wgd, the weight wpd, and the weight wvd, and generate the final empathy degree on the basis of the gaze consistency degree.

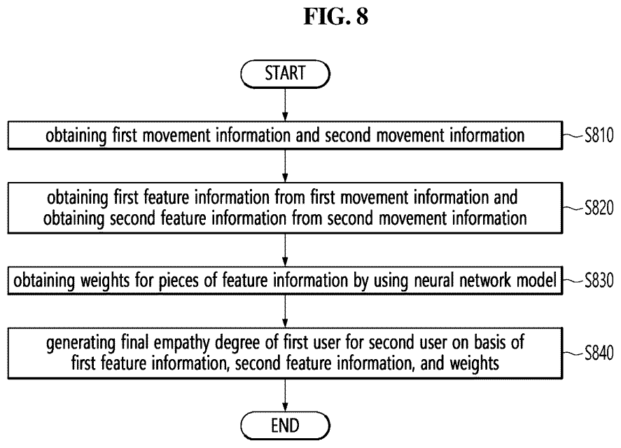

FIG. 8 is a flowchart illustrating an operating method of an electronic device according to an exemplary embodiment of the present disclosure. Specifically, FIG. 8 may show an operating method of a processor (e.g., the processor 200 of FIG. 1).

In step S810, an electronic device may obtain first movement information and second movement information. The movement information may mean movements of a user responding to an extended reality image. Exemplarily, the movement information may be obtained from a sensing unit (e.g., the sensing unit 100 of FIG. 1). However, it is not necessarily limited thereto, and the movement information may also be transmitted from a HMD device to the electronic device. The first movement information may mean movement information of a first user and the second movement information may mean movement information of a second user.

In step S820, the electronic device may obtain first feature information from the first movement information. The first feature information may include at least one of gaze information, face information, and position information of the first user. The position information may include head position information, wrist position information, and hand position information of the first user. The electronic device may obtain second feature information from the second movement information. The second feature information may include at least one of gaze information, face information, and position information of the second user. The position information may include head position information, wrist position information, and hand position information of the second user.

In step S830, the electronic device may obtain weights for pieces of feature information by using a neural network model. Exemplarily, the electronic device may obtain a weight for each feature value to generate a final empathy degree. The neural network model may update the weights through training, and the weights of the neural network model may be used as the weights for the respective feature values to generate the final empathy degree.

The neural network model may perform learning on the basis of sample feature information and a sample empathy degree. The sample feature information may include gaze information, face information, and position information, which are used to generate a final empathy degree and obtained from training movement information. The sample empathy degree may be a degree of empathy directly responded by a user, who generated the training movement information, for another user. The neural network model may be learned on the basis of supervised learning with the sample feature information set as an input and the sample empathy degree as a correct answer.

In step S840, the electronic device may generate a final empathy degree of the first user for the second user on the basis of the first feature information, the second feature information, and the weights. The electronic device may generate the final empathy degree on the basis of an emotional empathy degree and a physical empathy degree. The emotional empathy degree may mean a degree to which a physiological response generated depending on a target user's degree of empathy for another user is explicitly expressed in terms of gaze and facial expressions. The electronic device may calculate the emotional empathy degree on the basis of the first feature information, the second feature information, and the weights.

Exemplarily, the electronic device may obtain the first user's gaze information and face information which are first feature information, and may obtain the second user's gaze information and face information which are second feature information. The electronic device may obtain a gaze consistency degree and a facial expression similarity degree on the basis of the gaze information and face information of the first user and second user, and may generate the emotional empathy degree on the basis of the gaze consistency degree and the facial expression similarity degree.

The physical empathy degree may mean a degree to which a physiological response generated depending on a degree of the target user's empathy for another user is explicitly expressed in terms of distances and movements between the bodies of the users. The electronic device may calculate the physical empathy degree on the basis of the first feature information, the second feature information, and the weights.

Exemplarily, the electronic device may obtain the first user's position information which is first feature information, and obtain the second user's position information which is second feature information. The electronic device may obtain a physical proximity degree and a movement similarity degree on the basis of the position information of the first user and second user, and generate the physical empathy degree on the basis of the physical proximity degree and the movement similarity degree.

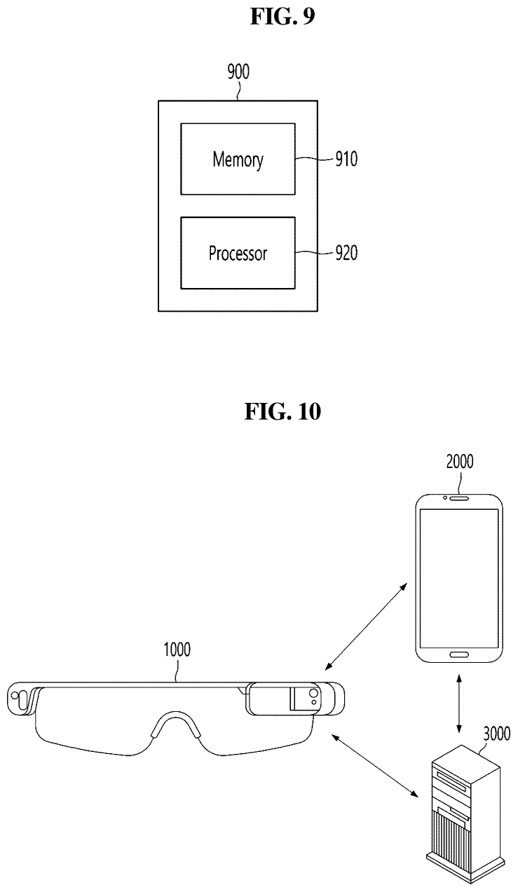

FIG. 9 is a block diagram illustrating an electronic device according to the exemplary embodiment of the present disclosure. Content redundant with the above-described content is omitted.

Referring to FIG. 9, the electronic device 900 may include a memory 910 and a processor 920. The memory 910 may store a program executed in the processor 920. For example, the memory 910 may include instructions for the processor 920 to generate a final empathy degree. The processor 920 may generate the final empathy degree of a first user by executing the program.

The memory 910 is a storage for storing data, and may store, for example, various algorithms, various programs, and various data. Memory 910 may store one or more instructions. The memory 1100 may include at least one of a volatile memory or a non-volatile memory. The non-volatile memory may include a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), etc. The volatile memory may include a dynamic RAM (DRAM), a static RAM (SRAM), a synchronous DRAM (SDRAM), a phase-change RAM (PRAM), a magnetic RAM (MRAM), a resistive RAM (RRAM), etc. In addition, in the exemplary embodiment, the memory 1100 may also include at least one of a hard disk drive (HDD), a solid state drive (SSD), a compact flash (CF), a secure digital (SD), a micro secure digital (Micro-SD), a mini secure digital (Mini-SD) memory card, an extreme digital (xD) memory card, or a memory stick. In the exemplary embodiment, the memory 910 may semi-permanently or temporarily store algorithms, programs, and one or more instructions, which are executed by the processor 920.

The processor 920 may control the overall operation of the electronic device 900. The processor 920 may include one or more of a central processing unit (CPU), an application processor (AP), or a communication processor (CP). For example, the processor 920 may perform operations or data processing related to control and/or communication of at least one or more other components of the electronic device 900.

The processor 920 may execute a program stored in the memory 910 to generate a final empathy degree of a first user for a second user. The processor 920 may obtain first movement information about at least one body part of the first user responding to an extended reality image. The processor 920 may obtain second movement information about at least one body part of the second user responding to the extended reality image. The electronic device 900 may receive the first movement information from a display device used by the first user, for example, a first HMD device. The electronic device 900 may receive the second movement information from a display device used by the second user, for example, a second HMD device.

The processor 920 may obtain first feature information from the first movement information and obtain second feature information from the second movement information. The processor 920 may obtain weights for pieces of feature information by using a neural network model. The processor 920 may use the weights of the neural network model as weights of feature values for generating a final empathy degree. The processor 920 may execute a program to generate the final empathy degree of the first user for the second user on the basis of the first feature information, the second feature information, and the weights.

FIG. 10 is a view illustrating a wearable device system according to an exemplary embodiment of the present disclosure.

Referring to FIG. 10, the wearable device system may include a wearable electronic device 1000, a mobile terminal 2000, and a server 3000. The display device described in the present specification may be included in the wearable electronic device 1000. The wearable device system may also be implemented with more components than those components shown in FIG. 10, or the wearable device system may also be implemented with fewer components than those components shown in FIG. 9. For example, the wearable device system may be implemented with the wearable electronic device 1000 and the mobile terminal 2000, or may be implemented with the wearable electronic device 1000 and the server 3000.

The wearable electronic device 1000 may be connected to the mobile terminal 2000 or the server 3000 for communication. For example, the wearable electronic device 1000 may perform short-range communication with the mobile terminal 2000. Examples of short-range communication may include wireless LAN (Wi-Fi), Near Field Communication (NFC), Bluetooth, Bluetooth Low Energy (BLE), ZigBee, Wi-Fi Direct (WFD), Ultra-wideband (UWB), etc., but is not limited thereto. Meanwhile, the wearable electronic device 1000 may also be connected to the server 3000 through wireless communication or mobile communication. The mobile terminal 2000 may transmit certain data to the wearable electronic device 1000 or receive certain data from the wearable electronic device 1000.

Meanwhile, the mobile terminal 2000 may be implemented in various forms. For example, the mobile terminal 2000 described in the present specification may include a mobile phone, a smartphone, a laptop computer, a tablet PC, an e-book terminal, a digital broadcasting terminal, a personal digital assistant (PDA), a portable multimedia player (PMP), a navigation device, an MP3 player, a digital camera, etc., but it is not limited thereto.

The server 3000 may be a cloud server for managing the wearable electronic device 1000.

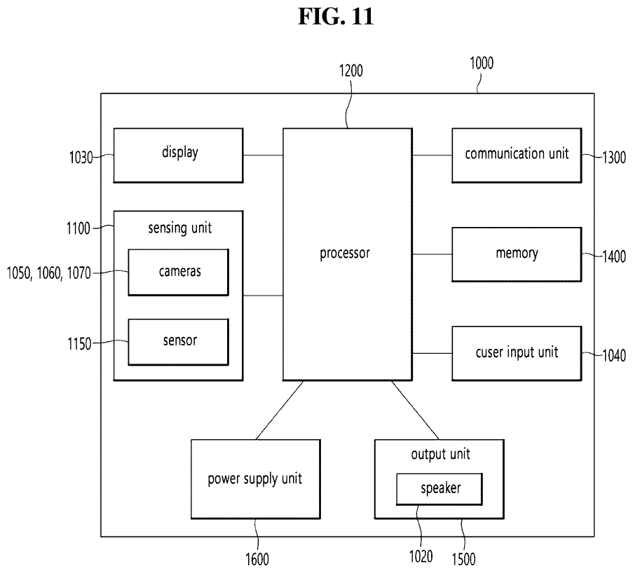

FIG. 11 is a block diagram illustrating a wearable electronic device according to an exemplary embodiment of the present disclosure. The wearable electronic device 1000 of FIG. 11 may correspond to the wearable electronic device 1000 of FIG. 10.

Referring to FIG. 11, the wearable electronic device 1000 according to the exemplary embodiment may include a sensing unit 1100, a processor 1200, and a display 1030. The wearable electronic device 1000 of FIG. 11 may correspond to the display device described in FIG. 1. Since the sensing unit 1100, processor 1200, and display 1030 in FIG. 11 respectively correspond to the sensing unit 100, processor 200, and display panel 300 in FIG. 1, redundant content is omitted.

In the exemplary embodiment, the display 1030 may be the display panel 300 described in FIG. 1. The display 1030 may display an extended reality image to a user on the basis of information processed by the wearable electronic device 1000.

The sensing unit 1100 may obtain information about body parts of the user or information about gestures of the user. Movement information may include body part movement information obtained through sensors, and images obtained by photographing body parts of the user, etc.

Referring to FIG. 11, the wearable electronic device 1000 may further include a communication unit 1300, a memory 1400, a user input unit 1040, an output unit 1500, and a power supply unit 1600. According to the exemplary embodiment of the present disclosure, the sensing unit 1100 may include at least one or more of cameras 1050, 1060, and 1070 and a sensor 1150. Exemplarily, the various components described above may be connected to each other through a bus.

The processor 1200 may control the overall operation of the wearable electronic device 1000. For example, by executing programs stored in the processor 1200 and the memory 1400, the display 1030, sensing unit 1100, communication unit 1300, memory 1400, user input unit 1040, output unit 1500, and power supply unit 1600 may be controlled. In the exemplary embodiment, the processor 1200 may generate a final empathy degree of a target user on the basis of movement information.

The cameras 1050, 1060, and 1070 photograph objects in real space. Object images captured by the cameras 1050, 1060, and 1070 may be moving images or continuous still images. The wearable electronic device 1000 may be, for example, a device in the form of glasses provided with a communication function and a data processing function. In the wearable electronic device 1000 worn by a user, the camera 1050 facing in front of the user may photograph objects in the real space.

In addition, the camera 1060 may photograph eyes of the user. For example, in the wearable electronic device 1000 worn by the user, the camera 1060 facing the user's face may photograph the user's eyes.

In addition, an eye tracking camera 1070 may photograph the user's eyes. For example, the eye tracking camera 1070 facing the user's face in the wearable electronic device 1000 worn by the user may photograph head poses, eyelids, pupils, etc. of the user.

For example, the sensor 1150 may include a geomagnetic sensor, an acceleration sensor, a gyroscope sensor, a proximity sensor, an optical sensor, a depth sensor, an infrared sensor, an ultrasonic sensor, etc.

The communication unit 1300 may transmit and receive information, which is required for the wearable electronic device 1000 to display images and generate a final empathy degree, with a device, a peripheral device, or a server.

The memory 1400 may store information required for the wearable electronic device 1000 to generate the final empathy degree.

The user input unit 1040 receives user input for controlling the wearable electronic device 1000. The user input unit 1040 may receive touch input and key input for the wearable electronic device 1000.

The power supply unit 1600 supplies power required for operation of the wearable electronic device 1000 to each component. The power supply unit 1600 may include a battery (not shown) capable of charging power, and may include a cable (not shown) or cable port (not shown), which is capable of receiving power from the outside.

The output unit 1500 may include a speaker 1020 for outputting audio data. In addition, the speaker 1020 may output sound signals (e.g., call signal reception sound, message reception sound, and notification sound) related to functions performed by the wearable electronic device 1000.

As described above, the exemplary embodiments are disclosed in the drawings and specification. In the present specification, the exemplary embodiments have been described by using specific terms, but this is only used for the purpose of describing the technical idea of the present disclosure and is not used to limit the meaning or scope of the present disclosure as set forth in the patent claims. Accordingly, those skilled in the art will understand that various modifications and other equivalent embodiments are applicable. Therefore, the true technical protection scope of the present disclosure should be determined by the technical spirit of the attached patent claims.

What is claimed is:

1. A display device, comprising:
a sensing unit configured to obtain movement information about at least one body part of a target user responding to an extended reality (XR) image output by a display panel; and
a processor operably connected to the sensing unit, wherein the processor is configured to generate the extended reality image from movements of the target user on the basis of the movement information, calculate an emotional empathy degree and a physical empathy degree for another user on the basis of the movement information the target user and movement information of the other user, and generate a final empathy degree of the target user for the other user on the basis of the emotional empathy degree and the physical empathy degree.

2. The display device of claim 1, wherein the processor is configured to obtain gaze information of each of the target user and the other user from the movement information of each of the target user and the other user, generate a gaze consistency degree between the target user and the other user by using the gaze information, obtains face information of each of the target user and the other user from the movement information of each of the target user and the other user, generate a facial expression similarity degree between the target user and the other user by using the face information, and generate the emotional empathy degree on the basis of at least one of the gaze consistency degree and the facial expression similarity degree.

3. The display device of claim 2, wherein the gaze information comprises at least one of gaze direction information, pupil information, and eye movement information, and
wherein the processor is configured to generate the gaze consistency degree on the basis of at least one of a similarity degree in gaze directions between the target user and the other user, a difference in pupil sizes between the target user and the other user, or a difference in eye movement speeds between the target user and the other user.

4. The display device of claim 3, wherein the higher the similarity degree in the gaze directions is, the higher the gaze consistency degree is, and
the smaller the difference in the pupil sizes and the difference in the eye movement speeds are, the higher the gaze consistency degree is.

5. The display device of claim 2, wherein the face information comprises movement information of facial muscles corresponding to at least one of a plurality of parts of a face, and
wherein the processor is configured to generate the facial expression similarity degree on the basis of movement information of facial muscles.

6. The display device of claim 1, wherein the processor is configured to obtain position information between the target user and the other user from the movement information of each of the target user and the other user, generate a physical proximity degree and a movement similarity degree between the target user and the other user on the basis of the position information, and generate the physical empathy degree on the basis of at least one of the physical proximity degree or the movement similarity degree.

7. The display device of claim 6, wherein the position information comprises head position information of the target user and wrist position information of the users, and
wherein the processor is configured to generate the physical proximity degree on the basis of at least one of a distance between a head position of the target user and a head position of the other user or distances between wrist positions of the user and wrist positions of the other user.

8. The display device of claim 7, wherein the closer the distance between the head position of the target user and the head position of the other user is, the higher the physical proximity degree is, and
the closer the distances between the wrist positions of the target user and the wrist positions of the other user are, the higher the physical proximity degree is.

9. The display device of claim 6, wherein the position information comprises head position information of the users and wrist position information of the users, and
wherein the processor is configured to generate the movement similarity degree on the basis of a difference between a first center position relative to the head position and the both wrist positions of the target user and a second center position relative to the head position and the both wrist positions of the other user.

10. The display device of claim 6, wherein the position information comprises hand position information of the users, and
wherein the processor is configured to generate the movement similarity degree on the basis of at least one of differences in positions of fingers between both of the target user or the other user and differences in angles of finger joints between the target user and the other user.

11. The display device of claim 1, wherein the display device comprises a neural network model trained on the basis of a sample empathy degree responded by the target user for the other user and sample feature information comprising gaze information, face movement information, and position information which are obtained from training movement information and used to generate the final empathy degree, and
wherein the processor is configured to generate the final empathy degree on the basis of weights of the neural network model.

12. An electronic device comprising:
a memory for storing at least one instruction; and
at least one processor operably connected to the memory, wherein the at least one processor is configured to:
wherein the at least one processor is configured to execute the at least one instruction, so as to receive first movement information for at least one body part of a first user responding to an extended reality (XR) image or second movement information for at least one body part of a second user responding to the extended reality image, obtain first feature information comprising gaze information, face information, and position information of the first user from the first movement information, obtain second feature information comprising gaze information, face information, and position information of the second user from the second movement information, obtain weights for pieces of the feature information by using a neural network model, and generate a final empathy degree of the first user for the second user on the basis of the first feature information, the second feature information, and the weights.

13. The electronic device of claim 12, wherein the at least one processor is configured to generate a gaze consistency degree between the first user and the second user on the basis of the gaze information of the first user and the gaze information of the second user, generate a facial expression similarity degree between the first user and the second user on the basis of the face information of the first user and the face information of the second user, and generate the final empathy degree on the basis of at least one of the gaze consistency degree and the facial expression similarity degree.

14. The electronic device of claim 13, wherein the gaze information comprises at least one of gaze direction information, pupil information, or eye movement information, and
wherein the at least one processor is configured to generate the gaze consistency degree on the basis of at least one of a similarity degree in gaze directions between the first user and the second user, a difference in pupil sizes between the first user and the second user, and a difference in eye movement speeds between the first user and the second user.

15. The electronic device of claim 13, wherein the face information comprises movement information of facial muscles corresponding to at least one of a plurality of parts of a face, and
wherein the at least one processor is configured to generate the facial expression similarity degree on the basis of the movement information of the facial muscles.

16. The electronic device of claim 12, wherein the at least one processor is configured to obtain the position information between the first user and the second user from the movement information of each of the first user and the second user, generates a physical proximity degree and a movement similarity degree between the first user and the second user on the basis of the position information, and generate the final empathy degree on the basis of at least one of the physical proximity degree and the movement similarity degree.

17. The electronic device of claim 16, wherein the position information comprises head position information of the users and wrist position information of the users, and
wherein the at least one processor is configured to generate the physical proximity degree on the basis of at least one of a distance between a head position of the first user and a head position of the second user and distances between wrist positions of the first user and wrist positions of the second user.

18. The electronic device of claim 16, wherein the position information comprises head position information, wrist position information, and hand position information of the users, and
wherein the at least one processor is configured to generate the movement similarity degree on the basis of a difference between a first center position relative to the head position and the both wrist positions of the first user and a second center position relative to the head position and the both wrist positions of the second user, and a difference in angles of finger joints between of the first user and the second user.

19. A wearable electronic device, comprising:
a display panel for outputting an extended reality (XR) image to users;
a sensing unit operably connected to the display panel, where the sensing unit is configured to obtain first movement information about at least one body part of a first user responding to the extended reality image;
a communication unit operably connected to the sensing unit, wherein the communication unit is configured to receive second movement information about at least one body part of a second user responding to the extended reality image; and
a processor operably connected to the communication unit, wherein the processor is configured to calculate an emotional empathy degree and a physical empathy degree of the first user for the second user on the basis of the first movement information and the second movement information and generate a final empathy degree of the first user for the second user on the basis of the emotional empathy degree and the physical empathy degree.
